(19) United States
(12) Patent Application Publication
(10) Pub. No.: US 2012/0195362 A1
(43) Pub. Date: Aug. 2, 2012

(54) System and Method for Managing Cache Storage in Adaptive Video Streaming System

(75) Inventors: Steven A. Benno, Towaco, NJ (US); Jairo O. Esteban, Freehold, NJ (US); Ivica Rimac, Tinton Falls, NJ (US)

(73) Assignee: ALCATEL-LUCENT USA INC., Murray Hill, NJ (US)

(21) Appl. No.: 13/019,741

(22) Filed: Feb. 2, 2011

(51) Int. Cl. H04N 7/26

(52) U.S. Cl. 375/240.01; 375/E07.026

(57) ABSTRACT

A normalized cost measure is determined for each encoded video segment within each of a plurality of sequences of encoded video segments that are associated with a video program and stored in a cache memory, relative to the sequence to which the encoded video segment belongs. One or more encoded video segments are selected from among the encoded video segments in the plurality of sequences, based on the normalized cost measures. The selected encoded video segments are removed from the cache memory. An encoded video segment having a lowest normalized cost measure among the encoded video segments in the plurality of sequences may be selected, for example.

### FIELD OF THE INVENTION

This invention relates generally to systems and methods for streaming data in a network, and more particularly to systems and methods for managing cache storage in an adaptive video streaming system.

### BACKGROUND

The use of video streaming is commonly used to deliver video data via the Internet and other networks. Typically, a video server divides a video program into segments, encodes each segment, and transmits the encoded segments via a network to a client device. The client device receives the encoded segments, decodes the segments, and presents the decoded segments in an appropriate sequence to produce a video presentation.

To facilitate the delivery of encoded video segments to a client device, selected encoded segments may be stored in a cache memory at a selected location in the network. When the client device requests an encoded segment associated with a video program, the cache may provide the requested encoded segment if it is stored in the cache (a condition known as a cache hit). If the encoded segment is not stored in the cache (a condition known as a cache miss), it may be necessary for the cache to obtain the encoded segment from the video server or from another source. A high number or a high frequency of cache misses may adversely affect the ability of the client device to produce a quality video presentation.

### SUMMARY OF THE INVENTION

In accordance with an embodiment of the invention, a method for managing data in a cache memory is provided. An encoded video segment is selected from each of a plurality of sequences of encoded video segments that are associated with a video program and stored in a cache memory, based on cost measures of the encoded video segments. An encoded video segment may be selected from each respective sequence based on a comparison of the cost measures of the encoded video segments within the sequence, for example. The selected encoded video segments are removed from the cache memory. Each sequence may be associated with a respective encoding rate.

The cache memory may comprise a random access memory in a cache device. The removed segments may be stored in a storage in the cache device that is different from the cache memory.

In one embodiment, the cost measure for each encoded video segment is determined based on an encoding rate associated with the encoded video segment. An encoded video segment having a lowest cost measure may be selected from each of the plurality of sequences of encoded video segments. In another embodiment, the cost measure for each encoded video segment is determined based on a size of the encoded video segment.

In another embodiment, a method for managing data in a cache memory is provided. An encoded video segment is selected from each of a plurality of sequences of encoded video segments associated with a video program, based on cost measures of the encoded video segments. The selected encoded video segments are transmitted to a cache memory, and stored. The respective sequences of encoded video segments may be generated by encoding the video program at multiple encoding rates.

In one embodiment, the cost measure for each encoded video segment is determined based on an encoding rate associated with the encoded video segment. An encoded video segment having a highest cost measure may be selected from each of the plurality of sequences of encoded video segments. In another embodiment, the cost measure for each encoded video segment is determined based on a size of the encoded video segment.

In another embodiment of the invention, a method for managing data in a cache memory is provided. A normalized cost measure is determined for each encoded video segment within each of a plurality of sequences of encoded video segments that are associated with a video program and stored in a cache memory, relative to the sequence to which the encoded video segment belongs. One or more encoded video segments are selected from among the encoded video segments in the plurality of sequences, based on the normalized cost measures. The selected encoded video segments are removed from the cache memory.

In one embodiment, each sequence in the plurality of sequences comprises an encoded version of the video program encoded at a respective encoding rate. The normalized cost measure of a respective encoded video segment within a respective sequence may be determined by dividing a first encoding rate associated with the respective encoded video segment by a second encoding rate associated with the respective sequence to which the respective encoded video segment belongs. An encoded video segment having a lowest normalized cost measure among the encoded video segments in the plurality of sequences may be selected, for example.

In another embodiment, a method for transmitting data to a cache memory is provided. A normalized cost measure is determined for each encoded video segment within each of a plurality of sequences of encoded video segments that are associated with a video program. One or more encoded video segments are selected from among the encoded video segments in the plurality of sequences, based on the normalized cost measures. The selected encoded video segments are transmitted to a cache memory. An encoded video segment having a highest normalized cost measure among the encoded video segments in the plurality of sequences may be selected, for example.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to stream video data in accordance with an embodiment of the invention;

FIG. 2 shows functional components of a client device in accordance with an embodiment of the invention;

FIG. 3 shows video segments of a video program and corresponding chunks in accordance with an embodiment of the invention;

FIG. 4 shows functional components of a cache in accordance with an embodiment of the invention;

FIG. 5 is a flowchart of a method for removing video data stored in a cache in accordance with an embodiment of the invention;

FIG. 6 shows the cache of FIG. 4 after selected chunks have been removed in accordance with an embodiment of the invention;

FIG. 6B is a flowchart of a method for removing video data stored in a cache in accordance with an embodiment of the invention;

FIG. 7A shows video segments of a video program and corresponding chunks in accordance with an embodiment of the invention;

FIG. 7B is a flowchart of a method for transmitting data to a cache memory in accordance with an embodiment of the invention;

FIG. 7C shows a cache after selected chunks have been stored in accordance with an embodiment of the invention;

FIG. 7D is a flowchart of a method for transmitting data to a cache memory in accordance with an embodiment of the invention; and

FIG. 8 shows a computer which may be used to implement the invention.

### DETAILED DESCRIPTION

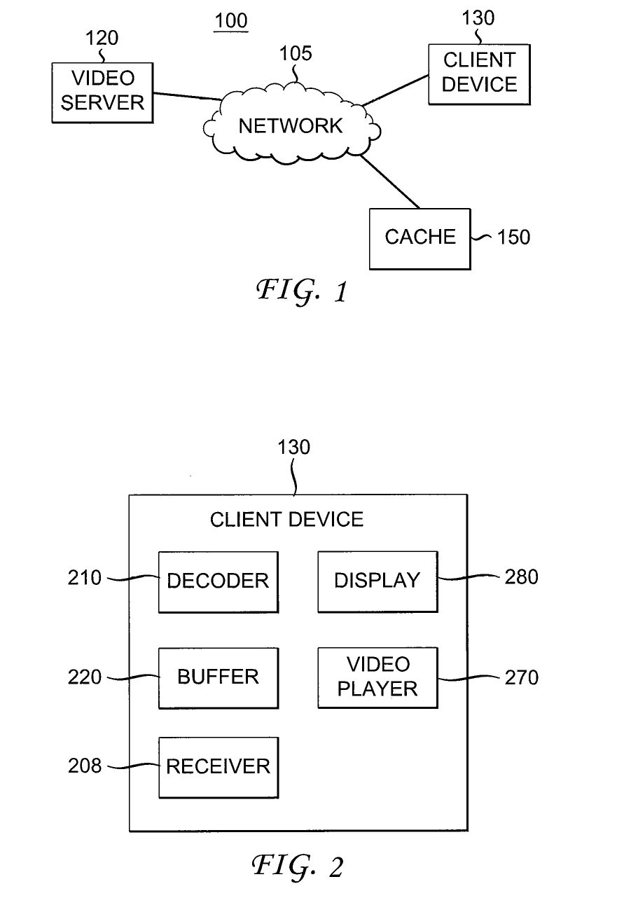

FIG. 1 shows a communication system 100 that may be used to stream video data in accordance with an embodiment of the invention. Communication system 100 comprises a network 105, a video server 120, a client device 130, and a cache 150.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

In the exemplary embodiment of FIG. 1, one video server 120 is shown; however, communication system 100 may comprise any number of video servers. Similarly, one client device 130 and one cache 150 are shown in FIG. 1; however, communication system 100 may comprise any number of clients and any number of caches.

Video server 120 streams video data via network 105 to client device 130. Techniques for video streaming are known. Video server 120 may encode video data before transmitting the data to client device 130. Video server 120 may store video data in a storage device, for example. Alternatively, video server 120 may receive video data from other sources.

Client device 130 receives video data via network 105, decodes the data (if necessary), and presents the resulting video program. The video program may be shown on a display device, for example.

FIG. 2 shows functional components of client device 130 in accordance with an embodiment of the invention. Client device 130 comprises a receiver 208, a decoder 210, a buffer 220, a video player 270, and a display 280. Encoded video data is received via network 105 by receiver 208 and stored in buffer 220. Decoder 210 decodes the encoded video data. Video player 270 plays back decoded video data to produce a video presentation. A video program may be presented on display 280. Client device 130 may comprise other components in addition to those shown in FIG. 2.

In one embodiment, buffer 220 has a specified size defined as a time period T; when full, buffer 220 stores an amount of encoded video data corresponding to T seconds of a video program. For example, a buffer may be described as having a capacity to hold fifteen seconds of video data. Therefore, the size of buffer 220, measured in bytes, may vary.

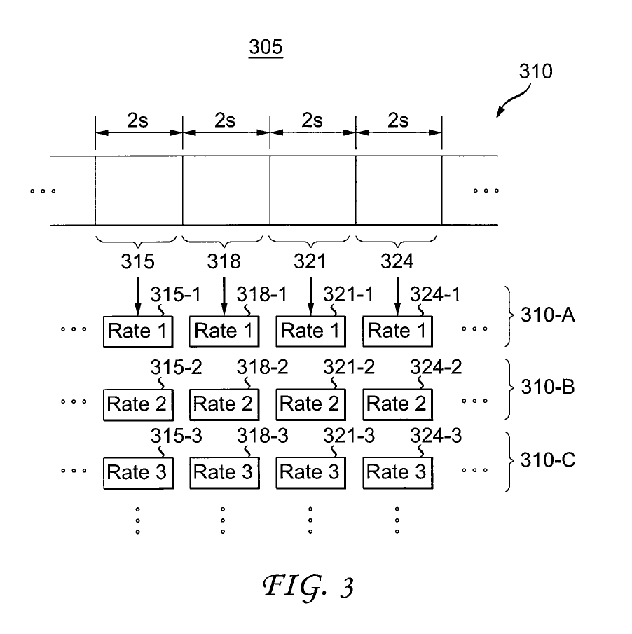

Video server 120 divides a video program into a sequence of video segments, and encodes each segment in accordance with a selected delivery format. In one embodiment, each segment may contain from two to ten seconds of video data. FIG. 3 shows a video program 305 which has been divided into a sequence 310 of video segments in accordance with an embodiment of the invention. Sequence 310 comprises a plurality of two-second video segments, including segments 315, 318, 321, and 324.

In accordance with a technique known as HyperText Transfer Protocol (HTTP) adaptive streaming, some or all of the video segments in sequence 310 are encoded multiple times at different encoding rates, resulting in a plurality of encoded video segments (referred to as “chunks”) for each original video segment in sequence 310. Referring to FIG. 3, video segment 315 is encoded at Rate 1, resulting in chunk 315-1, at Rate 2, resulting in chunk 315-2, and at Rate 3, resulting in chunk 315-3. Rate 1, Rate 2, and Rate 3 are different. Similarly, segment 318 is encoded at Rate 1, Rate 2, and Rate 3, resulting in chunks 318-1, 318-2, and 318-3; segment 321 is encoded at Rate 1, Rate 2, and Rate 3, resulting in chunks 321-1, 321-2, and 321-3; and segment 324 is encoded at Rate 1, Rate 2, and Rate 3, resulting in chunks 324-1, 324-2, and 324-3. Other video segments in sequence 310 may also be encoded in this manner, resulting in multiple chunks for each segment. Typically, for a given video segment, a chunk that is encoded at a higher encoding rate is larger, i.e., contains more bits of data, than a chunk encoded at a lower encoding rate. Systems and methods for performing HTTP adaptive streaming of video data are known.

In FIG. 3, three sequences of chunks are shown. Each sequence is associated with an encoding rate (the “sequence rate”). Sequence 310-A is associated with Rate 1 and comprises chunks 315-1, 318-1, 321-1 and 324-1. Similarly, sequence 310-B is associated with Rate 2 and comprises chunks 315-2, 318-2, 321-2, and 324-2, and sequence 310-C is associated with Rate 3 and comprises chunks 315-3, 318-3, 321-3, and 324-3. However, each video segment in a sequence of video segments (such as sequence 310) may be encoded at more than three different encoding rates, or at fewer than three different encoding rates. In one embodiment, each video segment is encoded at between six and twelve different encoding rates between 300 Kbps and 2.4 Mbps. Other encoding rates, and other ranges of encoding rates, may be used.

Within a sequence of chunks encoded at a selected rate, such as sequence 310-A, each chunk may be associated with a particular bit rate (the “chunk bit rate” or “chunk rate”) different from the sequence rate. The chunk bit rate may be associated with the amount of data (e.g., the amount of bits) contained in the chunk, for example. In one embodiment, the chunk bit rate is determined by dividing the size of the chunk (i.e., the amount of data contained in the chunk) by the duration of the associated video segment.

Video server 120 may also generate a manifest file (not shown) identifying video segments associated with a respective video program, the corresponding chunks, and the encoding rates of the various chunks. The chunks, and the associated manifest file, may be stored on video server 120.

Prior to downloading a desired video program, client device 130 may download from video server 120, or otherwise access, the manifest file containing information concerning the desired video program, and identify the sequence of video segments associated with the video program. Supposing, for example, that client device 130 needs to play video program 305, client device 130 may access the relevant manifest file and determine that video program 305 comprises sequence 310 and is associated with segments 315, 318, 321, 324, etc. Client device 130 may select a particular video segment and transmits to video server 120 a request for a corresponding chunk. Video server 120, in response, transmits the requested chunks to client 120. As chunks are received by client device 130, client device 130 decodes the chunks and plays back the decoded video segments in an appropriate sequence to produce a video presentation.

For a particular video segment, client device 130 determines which chunk to request from among the corresponding chunks of different quality levels, based on a rate determination algorithm that considers various factors. In one embodiment, client device 130 selects a chunk that offers the highest sustainable quality level for current network conditions. For example, while receiving chunks corresponding to a sequence of video segments, client device 130 may periodically determine current available bandwidth based on the delay between transmission of a request for a respective chunk and receipt of the requested chunk, and determine a quality level of a subsequent chunk to be requested based on the current bandwidth. The rate determination algorithm may also consider the need to keep buffer 220 sufficiently full to avoid pauses, stops, and stutters in the presentation of the video stream.

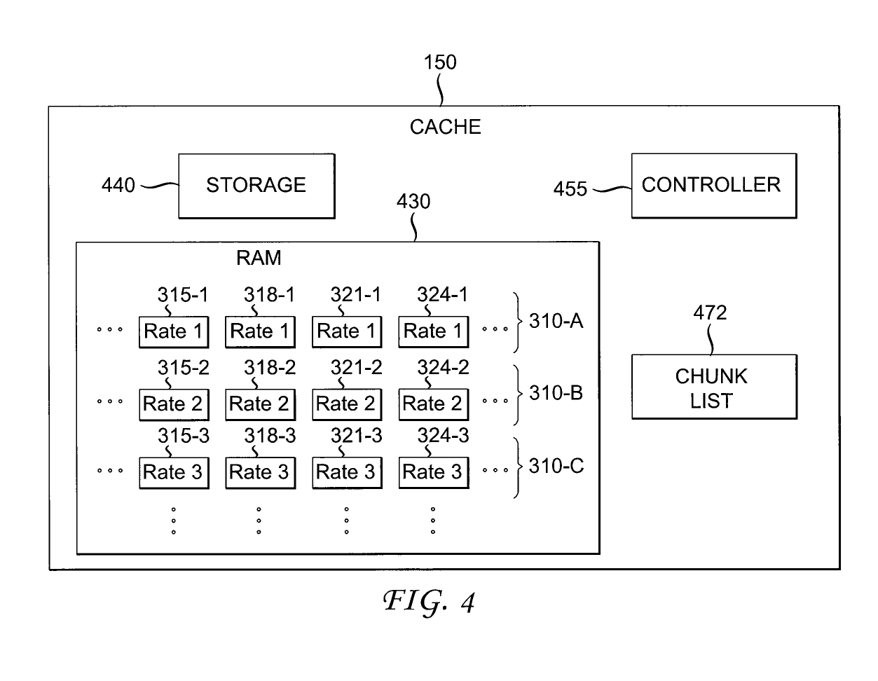

To facilitate the delivery of chunks associated with a video program, one or more chunks may be stored in cache 150 and accessed by client device 130 as needed. Cache 150 can ordinarily provide data to client device 130 more quickly than can video server 120. For example, cache 150 may be closer to client device 130 than video server 120. FIG. 4 shows functional components of cache 150 in accordance with an embodiment of the invention. Cache 150 comprises a controller 455, a random access memory (RAM) 430, a storage 440, and a chunk list 472. RAM 430 comprises a relatively high-speed memory device. Storage 440 comprises a memory device such as one or more disk drives. When a video program is being delivered to client device 130, controller 455 may receive chunks of video data from video server 120 and store the chunks in RAM 430 and/or in storage 440 based on one or more predetermined policies. For example, in the embodiment of FIG. 4, chunks 315-1, 315-2, 315-3, 318-1, 318-2, 318-3, 321-1, 321-2, 321-3, 324-1, 324-2, and 324-3 (associated with video program 305) are stored in RAM 430. In response to a request from client device 130, controller 455 may retrieve a chunk from RAM 430 or from storage 440 and transmits the chunk to client device 130. Chunk list 472 stores information identifying chunks that are stored in cache 150, video segments corresponding to the respective chunks, the chunks' encoding rates, the memory locations of the respective chunks, etc. While two cache memories (RAM 430 and storage 440) are shown in FIG. 4, cache 150 may comprise any number of cache memories, storage devices, etc.

In accordance with an embodiment of the invention, when client device 130 requires a chunk associated with a particular video program, a request for the chunk may first be made to cache 150. For example, client device 130 may transmit a request for the desired chunk to cache 150. Alternatively, video server 120 may transmit a request to cache 150 identifying the requested chunk and client device 130. In response to the request, controller 455 may determine the presence or absence in cache 150 of the requested chunk, for example, by consulting chunk list 472. If the requested chunk is stored in cache 150 (a condition referred to as a cache hit), cache 150 may transmit the requested chunk to client device 130.

If the requested chunk is not stored in cache 150 (a condition referred to as a cache miss), cache 150 may obtain the requested chunk from video server 120 and then provide the requested chunk to client device 130. After obtaining the requested chunk from video server 120, cache 150 may also store the chunk. In order to store a new chunk, it may be necessary for controller 455 to remove, or evict, one or more chunks currently stored in RAM 430 or in storage 440. Controller 455 may select chunks for eviction based on a predetermined replacement algorithm. Existing replacement algorithms select chunks for replacement based on parameters including frequency of chunk utilization, recency of chunk utilization, size of chunks, etc.

When a cache miss renders it necessary for a cache device, or a client device, to obtain a desired chunk from the video server or from another source, the client device's ability to produce a high quality video presentation may be adversely affected. Specifically, when the time required to download a desired chunk exceeds the associated playback time of the chunk, the delay may “drain” the client device's buffer. When a client device's buffer becomes low or empty, the client device's rate determination algorithm may determine that it is necessary to select chunks of lower quality, compromising the device's ability to produce a high quality video presentation.

In particular, a high number or high frequency of cache misses can adversely affect the performance of a client device's rate determination algorithm and reduce the quality of a video presentation produced by the client device. For example, repeated, or frequent, cache misses can drain the client device's buffer, causing a reduction in the quality level of the video presentation, or undesirable oscillations between quality levels in the video presentation.

In addition, the rate at which a client's buffer is drained may be affected by the type of video data that is downloaded. For example, a chunk containing data representing an image may contain more information and therefore be more problematic than a chunk containing data representing text. In this discussion, a chunk is considered to be more problematic than another chunk if it requires more time for a client device to download and render the chunk, and therefore is more likely to drain the client device's buffer. A chunk may be problematic for a client device to download and render due to the chunk's size (e.g., how many bits it contains), or due to the chunk bit rate, or for another reason. Efficient management of cache storage requires consideration of the effect of problematic chunks on a client's buffer, the client's rate determination algorithm, and the availability of chunks of differing quality levels in an HTTP adaptive video streaming system.

However, existing replacement algorithms used to manage video data stored in caches fail to consider the effect of problematic chunks on the rate determination algorithms used by client devices. Existing replacement algorithms also fail to consider the presence of multiple sequences of chunks with varying quality levels for a given video program. Cache replacement algorithms which keep the chunks having the largest size may tend to keep chunks associated with higher quality levels and eliminate chunks associated with lower quality levels, increasing the possibility of repeated cache misses when chunks from lower quality levels are requested. Repeated cache misses may cause undesirable effects in the clients' playback of a video program, as discussed above.

In accordance with embodiments described herein, a cost function is used to determine a cost measure for each respective chunk, indicating how problematic the chunk is, i.e., how much time is required for a client device to download and render the chunk. Storage of chunks in cache 150 is managed based on the cost measures of the chunks.

In certain embodiments described herein, a chunk's cost measure may be determined relative to other chunks in a sequence associated with a particular encoding rate. For example, a 2 Mbps chunk may not be problematic if it is part of a 2 Mbps sequence. However, a 2 Mbps chunk may be problematic if it is part of a 1 Mbps sequence because it may drain the buffer of a client device that can sustain a maximum rate of 1 Mbps. Therefore, the cost measure of a chunk in sequence 310-A is determined relative to other chunks in sequence 310-A, the cost measure of a chunk in sequence 310-B is determined relative to other chunks in sequence 310-B, and the cost measure of a chunk in sequence 310-C is determined relative to other chunks in sequence 310-C.

In accordance with an embodiment of the invention, a replacement algorithm is used which considers the effects of data eviction on a client device's rate determination algorithm. For example, a replacement algorithm may evict chunks that have low cost measures and keeps chunks that have high cost measures, on a sequence-by-sequence basis, in order to minimize excessive draining of the client device's buffer, thereby enabling the client to provide a video stream of consistent quality.

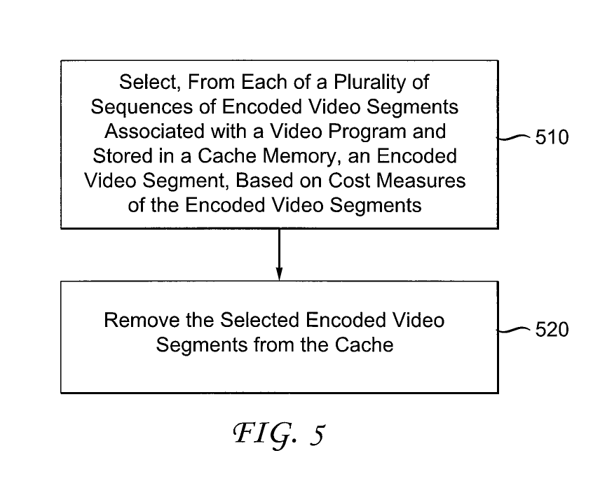

FIG. 5 is a flowchart of a method for removing video data stored in a cache in accordance with an embodiment of the invention. In an illustrative example, suppose that controller 455 receives new data to be stored in RAM 430, and determines that some data currently stored in RAM 430 must be evicted. Suppose further that controller 455 determines that a portion of the data chunks associated with video program 305 must be evicted from RAM 430.

At step 510, at least one encoded video segment is selected from each of a plurality of sequences of encoded video segments that are associated with a video program and stored in a cache memory, based on cost measures of the encoded video segments. Referring to FIG. 4, controller 455 determines a cost measure for each chunk in sequence 310-A, including chunks 315-1, 318-1, 321-1, 324-1, etc., and also determines a cost measure for each chunk in sequences 310-B and sequence 310-C.

In an exemplary embodiment, the cost measure for each chunk is determined based on the chunk bit rate. Accordingly, controller 455 determines the chunk bit rate for each chunk in each sequence.

In the exemplary embodiment, chunks are compared on a sequence-by-sequence basis, based on the cost measures of the chunks, and at least one chunk is selected from each sequence. The chunks in each sequence are examined and the chunk with the lowest cost measure relative to the other chunks in the sequence may be selected, for example. Therefore, the chunk in each sequence that has the lowest cost measure, i.e., the chunk in each sequence that is least problematic for a client device to download, may be selected. Referring to FIG. 4, controller 455 selects the chunk with the lowest chunk bit rate among the chunks in sequence 310-A, the chunk with the lowest chunk bit rate among the chunks in sequence 310-B, and the chunk with the lowest chunk bit rate among the chunks in sequence 310-C. In the exemplary embodiment, chunk 321-1 has the lowest chunk bit rate among the chunks in sequence 310-A, chunk 321-2 has the lowest chunk bit rate among the chunks in sequence 310-B, and chunk 321-3 has the lowest chunk bit rate among the chunks in sequence 310-C. In other embodiments, more than one chunk may be selected from each sequence. It is to be noted that because at least one chunk is selected from each sequence, the set of selected chunks may not be the same as a set of chunks determined by examining all the chunks in all the sequences as a group and selecting a set of chunks having the lowest cost measures from that group.

In other embodiments, the cost measure of a chunk may be determined based on the size of the chunk, the chunk's duration, the chunk's quality level, the chunk's decoding complexity, recency of chunk utilization, frequency of chunk utilization, the chunk's popularity, the topology of the network, and/or other factors.

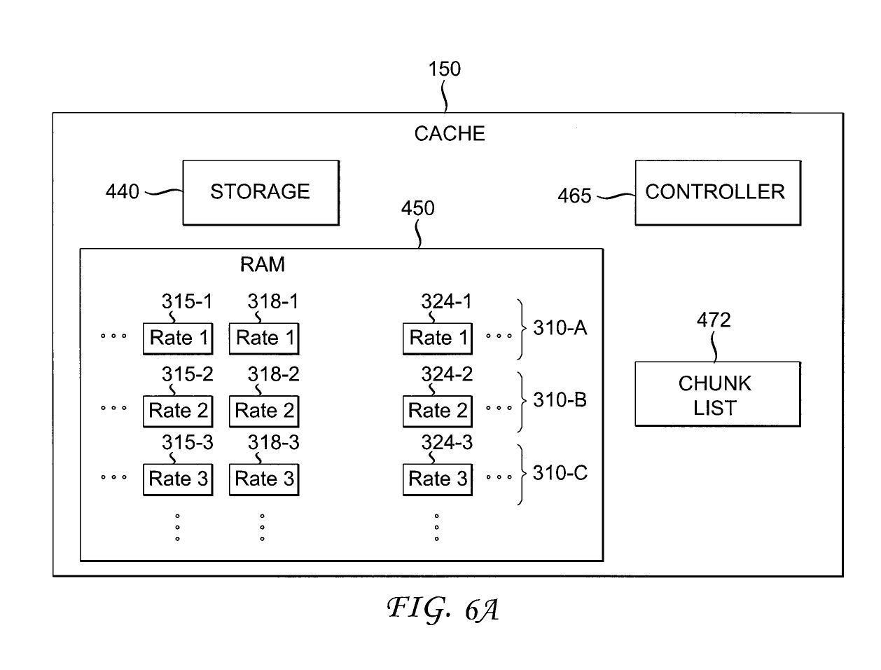

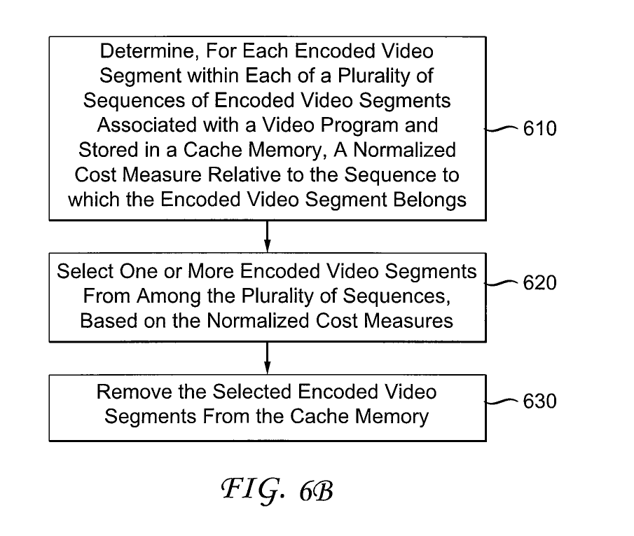

At step 520, the selected chunks from each sequence are removed from the cache memory. Controller 455 accordingly removes from RAM 430 chunks 321-1, 321-2, and 321-3. FIG. 6 shows cache 150 after the selected chunks have been evicted in accordance with an embodiment of the invention. Chunks 315-1, 318-1, and 324-1 remain in cache from sequence 310-A, chunks 315-2, 318-2, and 324-2 remain in cache 150 from sequence 310-B, chunks 315-3, 318-3, and 324-3 remain in cache 150 from sequence 310-C.

In another embodiment, a normalized cost measure for each respective chunk in each of a plurality of sequences stored in a cache is determined based on an analysis of the chunk relative to the sequence to which the chunk belongs. Chunks from all sequences are analyzed and compared, and chunks having the lowest normalized cost measures are selected and removed from the cache. Because the cost measures are normalized, the cost measures can be compared across sequences.

FIG. 6B is a flowchart of a method for removing video data stored in a cache in accordance with an embodiment of the invention. At step 610, controller 455 determines, for each encoded video segment within each of a plurality of sequences of encoded video segments associated with a video program and stored in a cache memory, a normalized cost measure relative to the sequence to which the encoded video segment belongs. In an exemplary embodiment, a chunk's cost measure is determined by dividing the chunk bit rate of the chunk by the sequence rate of the sequence to which the chunk belongs. Thus, a chunk having a 2.0 Mbps chunk bit rate within a sequence having a sequence rate of 2.0 Mbps would have a cost measure of 1.0. A chunk having a 2.0 Mbps chunk bit rate within a sequence having a sequence rate of 1.0 Mbps would have a cost measure of 2.0. Accordingly, referring to FIG. 4, controller 455 determines a cost measure for each chunk in sequence 310-A relative to sequence 310-A, for each chunk in sequence 310-B relative to sequence 310-B, for each chunk in sequence 310-C relative to sequence 310-C, etc.

At step 620, controller 455 selects one or more encoded video segments from among the plurality of sequences, based on the normalized cost measures. In the exemplary embodiment, controller 455 selects a set of chunks having the lowest cost measures from among the chunks in sequences 310-A, 310-B, 310-C, etc. Because the chunk rates are normalized, they can be compared across sequences. Therefore, controller 455 may examine all the chunks in all the sequences as a group, and select a set of chunks having the lowest cost measures from among all the chunks in all the sequences. Consequently, in this embodiment, controller 455 may not necessarily select a chunk from each sequence.

At step 630, the selected encoded video segments are removed from the cache. In this embodiment, controller 455 removes the selected chunks from RAM 430.

In other embodiments, a total score indicating how problematic it may be to download a chunk may be determined based on a combination of the chunk's cost measure (determined as discussed above) and one or more additional parameters such as the size of the chunk, the chunk's duration, the chunk's quality level, the chunk's decoding complexity, recency of chunk utilization, frequency of chunk utilization, the chunk's popularity, the topology of the network, and/or other factors. The methods described above, including the methods of FIGS. 5 and 6B, may be implemented using the total scores of the chunks in various sequences.

In one embodiment, evicted chunks are permanently removed from cache 150. In another embodiment, evicted chunks are removed from RAM 430 and stored in storage 440, which comprises a memory device that is slower than RAM 430.

In another embodiment, after a video program is encoded, generating multiple sequences of chunks associated with different encoding rates, selected chunks are pre-stored in a cache based on cost measures associated with the respective chunks. For example, chunks that are most problematic (most difficult for a client device to download) may be pre-stored in the cache.

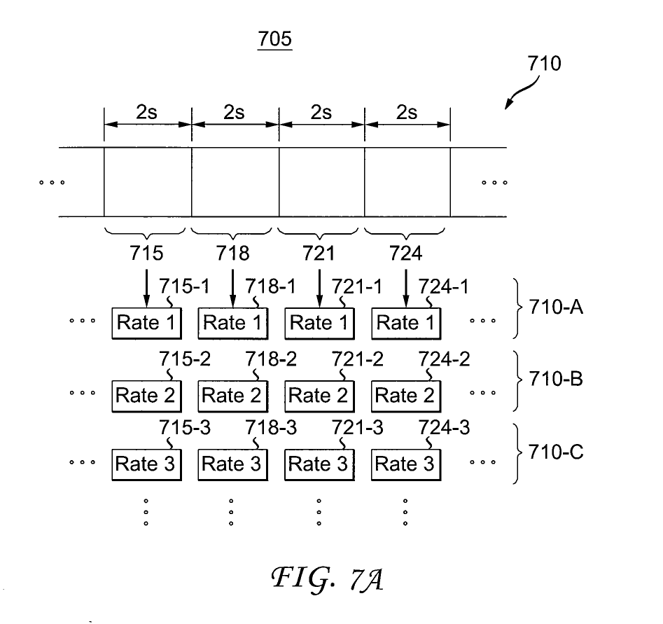

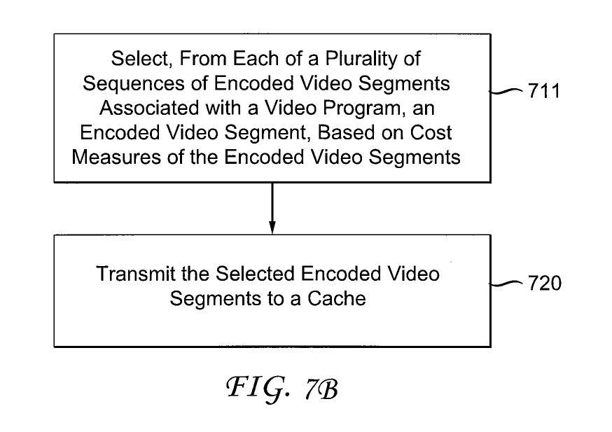

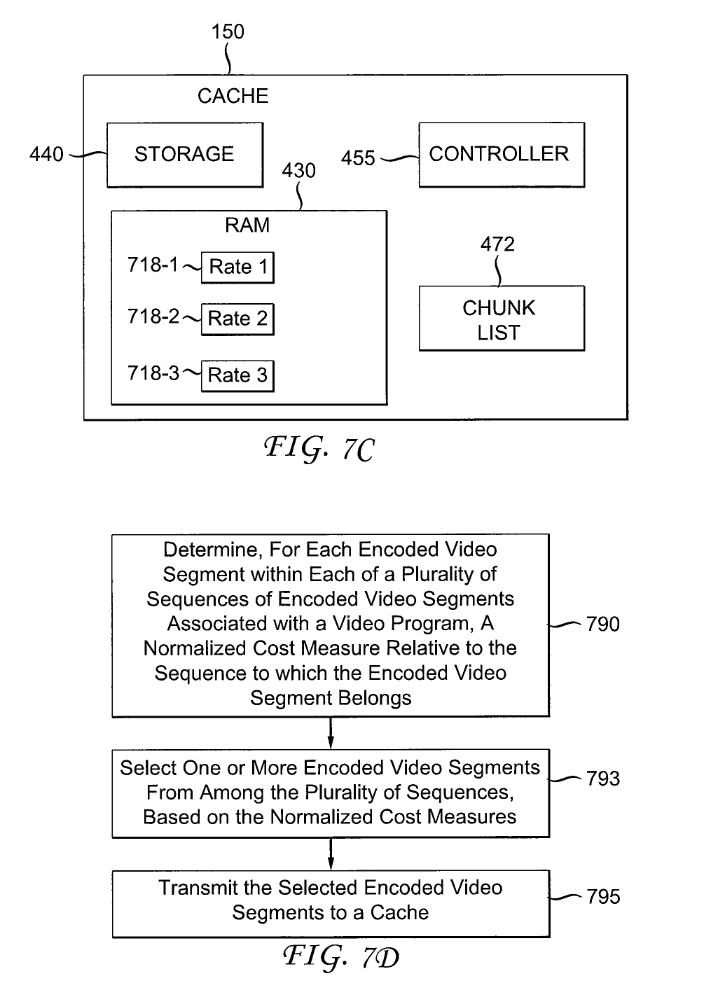

In an exemplary embodiment shown in FIG. 7A, a video program 705 is divided into a sequence 710 of segments including segments 715, 718, 721, and 724, in the manner described above. Segments 715, 718, 721, and 724 are encoded at multiple encoding rates, in the manner described above, to generate multiple sequences of chunks. In the exemplary embodiment, video server 120 encodes video program 705 to produce sequence 710-A, which is encoded at Rate 1 and includes chunks 715-1, 718-1, 721-1, and 724-1; sequence 710-B, which is encoded at Rate 2 and includes chunks 715-2, 718-2, 721-2, and 724-2; and sequence 710-C, which is encoded at Rate 3 and includes chunks 715-3, 718-3, 721-3, and 724-3. In other embodiments, another device may encode video program 705 and provide the encoded chunks to video server 120.

After video program 705 has been encoded, and before any request for a chunk is received from client device 130, video server 120 transmits selected chunks to cache 150 to be pre-stored. FIG. 7B is a flowchart of a method for selecting and transmitting chunks to a cache for storage in accordance with an embodiment of the invention. At step 711, at least one encoded video segment is selected from each of a plurality of sequences of encoded video segments associated with a video program, based on cost measures of the encoded video segments. Referring to FIG. 7A, video server 120 determines a cost measure for each chunk in sequence 710-A, including chunks 715-1, 718-1, 721-1, 724-1, etc. Video server 120 also determines a cost measure for each chunk in sequences 710-B and for each chunk in sequence 710-C.

In the exemplary embodiment, the cost measure comprises a chunk bit rate for each chunk. Accordingly, video server 120 determines the chunk bit rate for each chunk in each sequence.

Chunks are compared on a sequence-by-sequence basis, based on the cost measures of the chunks, and at least one chunk is selected from each sequence. For each sequence examined, the chunk having the highest cost measure relative to the other chunks in the sequence is selected. Thus, in the exemplary embodiment, for each sequence, the chunk having the highest chunk bit rate among the chunks in the sequence is selected. Chunks having the highest chunk bit rates are typically most difficult for a client device to download. Suppose, for example, that chunk 718-1 has the highest chunk bit rate among the chunks in sequence 710-A, and that chunks 718-2 and 718-3 have the highest chunk bit rates among sequences 710-B and 710-C, respectively. Video server 120 therefore selects chunks 718-1, 718-2 and 718-3. In other embodiments, more than one chunk may be selected from each sequence. It is to be noted that because a chunk is selected from each sequence, the set of selected chunks may not be the same as a set of chunks determined by examining all the chunks in all the sequences as a group and selecting the chunks having the highest cost measures from that group.

In other embodiments, the cost measure of a chunk may be determined based on the size of the chunk, the chunk's duration, the chunk's quality level, the chunk's decoding complexity, recency of chunk utilization, frequency of chunk utilization, the chunk's popularity, the topology of the network, and/or other factors.

At step 720, the selected chunks from each sequence are transmitted to a cache device. Therefore, video server 120 transmits chunks 718-1, 718-2, and 718-3 to cache 150. Video server 120 may also transmit to cache 150 a request that cache 150 store the transmitted chunks. In response, cache 150 stores the chunks received from video server 120. FIG. 7C shows cache 150 after chunks 718-1, 718-2, and 718-3 have been stored in RAM 430.

In another embodiment, a normalized cost measure for each respective chunk is determined based on an analysis of the chunk relative to the sequence to which the chunk belongs. One or more chunks are selected based on the normalized cost measures and are transmitted to a cache for storage.

FIG. 7D is a flowchart of a method for selecting and transmitting chunks to a cache for storage in accordance with an embodiment of the invention. At step 790, a normalized cost measure is determined for each encoded video segment within each of a plurality of sequences of encoded video segments associated with a video program, relative to the sequence to which the respective encoded video segment belongs. In the exemplary embodiment, a chunk's cost measure is determined by dividing the chunk bit rate of the chunk by the sequence rate of the sequence, in the manner discussed above. Referring to FIG. 7A, controller 455 determines a normalized cost measure for each chunk in sequence 710-A, for each chunk in sequence 710-B, for each chunk in sequence 710-C, etc.

At step 793, controller 455 selects one or more encoded video segments from among the plurality of sequences, based on the normalized cost measures. In the exemplary embodiment, controller 455 selects a set of chunks having the highest cost measures. Because the chunk rates are normalized, they can be compared across sequences. Therefore, controller 455 may examine all the chunks in all the sequences as a group, and select a set of chunks having the highest cost measures, from among all the chunks in all the sequences. Consequently, in this embodiment, controller 455 may not necessarily select a chunk from each sequence.

At step 795, controller transmits the selected chunks to cache 150. Cache 150 receives and stores the selected chunks.

In other embodiments, a total score indicating how problematic it may be to download a chunk may be determined based on a combination of the chunk's cost measure (determined as discussed above) and one or more additional parameters such as the size of the chunk, the chunk's duration, the chunk's quality level, the chunk's decoding complexity, recency of chunk utilization, frequency of chunk utilization, the chunk's popularity, the topology of the network, and/or other factors. The methods described above, including the method of FIGS. 7B and 7D, may be implemented using the total scores of the chunks in various sequences.

While the systems and methods described herein are discussed in the context of HTTP adaptive video streaming, this exemplary embodiment is not intended to be limiting. The systems and methods described herein may be used to stream other types of data.

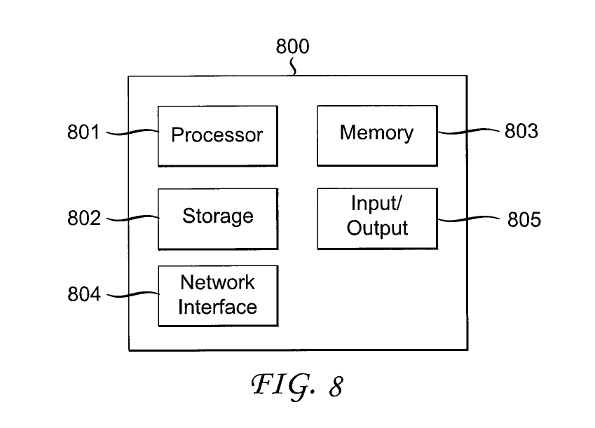

The above-described systems and methods can be implemented on one or more computers using well-known computer processors, memory units, storage devices, computer software, and other components. A high-level block diagram of such a computer is illustrated in FIG. 8. Computer 800 contains a processor 801, which controls the overall operation of computer 800 by executing computer program instructions that define such operations. The computer program instructions may be stored in a storage device 802, or other computer readable medium (e.g., magnetic disk, CD ROM, etc.), and loaded into memory 803 when execution of the computer program instructions is desired. Thus, the method steps of FIGS. 5, 6B, 7B and/or 7D can be defined by the computer program instructions stored in the memory 803 and/or storage 802 and controlled by the processor 801 executing the computer program instructions. For example, the computer program instructions can be implemented as computer executable code programmed by one skilled in the art to perform an algorithm defined by the method steps of FIGS. 5, 6B, 7B and/or 7D. Accordingly, by executing the computer program instructions, the processor 801 executes an algorithm defined by the method steps of FIGS. 5, 6B, 7B and/or 7D. Computer 800 also includes one or more network interfaces 804 for communicating with other devices via a network. Computer 800 also includes one or more input/output devices 805 that enable user interaction with computer 800 (e.g., display, keyboard, mouse, speakers, buttons, etc.). One skilled in the art will recognize that an implementation of an actual computer could contain other components as well, and that FIG. 8 is a high level representation of some of the components of such a computer for illustrative purposes. Computer 800 may also include peripherals, such as a printer, scanner, display screen, etc. For example, computer 800 may be a server computer, a mainframe computer, a personal computer, a laptop computer, a television, a cell phone, a multimedia player, etc. Other processing devices may be used.

Any or all of the systems and apparatus discussed herein, including video server 120, client device 130, and cache 150, and components thereof, including controller 455, storage 440, RAM 430, and chunk list 472, may be implemented using a computer such as computer 800.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for managing data in a cache memory, the method comprising:
selecting, from each of a plurality of sequences of encoded video segments that are associated with a video program and stored in a cache memory, an encoded video segment, based on cost measures of the encoded video segments; and
removing the selected encoded video segments from the cache memory.

2. The method of claim 1, wherein the cost measure for each encoded video segment is determined based on an encoding rate associated with the encoded video segment.

3. The method of claim 2, further comprising:
selecting, from each of the plurality of sequences of encoded video segments, an encoded video segment having a lowest cost measure.

4. The method of claim 1, wherein the cost measure for each encoded video segment is determined based on a size of the encoded video segment.

5. The method of claim 4, further comprising:
selecting, from each of the plurality of sequences of encoded video segments, an encoded video segment having a lowest cost measure.

6. The method of claim 1, wherein each sequence is associated with a respective encoding rate.

7. The method of claim 1, wherein the cache memory comprises a random access memory in a cache device.

8. The method of claim 1, further comprising:
storing the removed segments in a storage in a cache device that is different from the cache memory.

9. A method for managing data in a cache memory, the method comprising:
selecting, from each of a plurality of sequences of encoded video segments associated with a video program, an encoded video segment, based on cost measures of the encoded video segments; and
transmitting the selected encoded video segments to a cache memory.

10. The method of claim 9, further comprising:
determining the cost measure for each encoded video segment based on an encoding rate associated with the encoded video segment.

11. The method of claim 10, further comprising:
selecting, from each of the plurality of sequences of encoded video segments, an encoded video segment having a highest cost measure.

12. The method of claim 9, further comprising:
determining the cost measure for each encoded video segment based on a size of the encoded video segment.

13. The method of claim 12, further comprising:
selecting, from each of the plurality of sequences of encoded video segments, an encoded video segment having a highest cost measure.

14. The method of claim 9, wherein each sequence is associated with a respective encoding rate.

15. The method of claim 14, further comprising:
generating the respective sequences of encoded video segments by encoding the video program at multiple encoding rates.

16. A method for managing data in a cache memory, the method comprising:
determining, for each encoded video segment within each of a plurality of sequences of encoded video segments that are associated with a video program and stored in a cache memory, a normalized cost measure relative to the sequence to which the encoded video segment belongs;
selecting one or more encoded video segments from among the encoded video segments in the plurality of sequences, based on the normalized cost measures; and
removing the selected encoded video segments from the cache memory.

17. The method of claim 16, wherein each sequence in the plurality of sequences comprises an encoded version of the video program encoded at a respective encoding rate.

18. The method of claim 17, wherein the step of determining the normalized cost measure of a respective encoded video segment within a respective sequence further comprises:
dividing a first encoding rate associated with the respective encoded video segment by a second encoding rate associated with the respective sequence to which the respective encoded video segment belongs.

19. The method of claim 18, wherein the step of selecting one or more encoded video segments from among the encoded video segments in the plurality of sequences, based on the normalized cost measures, further comprises:
selecting an encoded video segments having a lowest normalized cost measure among the encoded video segments in the plurality of sequences.

20. The method of claim 16, wherein the cache memory comprises a random access memory in a cache device.

21. The method of claim 20, further comprising:
storing the removed segments in a storage in a cache device that is different from the cache memory.

22. A method for managing data in a cache memory, the method comprising:
determining, for each encoded video segment within each of a plurality of sequences of encoded video segments that are associated with a video program, a normalized cost measure relative to the sequence to which the encoded video segment belongs;
selecting one or more encoded video segments from among the encoded video segments in the plurality of sequences, based on the normalized cost measures; and
transmitting the selected encoded video segments to a cache memory.

23. The method of claim 22, wherein each sequence in the plurality of sequences comprises an encoded version of the video program encoded at a respective encoding rate.

24. The method of claim 23, wherein the step of determining the normalized cost measure of a respective encoded video segment within a respective sequence further comprises:
dividing a first encoding rate associated with the respective encoded video segment by a second encoding rate associated with the respective sequence to which the respective encoded video segment belongs.

25. The method of claim 24, wherein the step of selecting one or more encoded video segments from among the encoded video segments in the plurality of sequences, based on the normalized cost measures, further comprises:
selecting an encoded video segments having a highest normalized cost measure among the encoded video segments in the plurality of sequences.

26. An apparatus for managing data, the apparatus comprising:
means for determining, for each encoded video segment within each of a plurality of sequences of encoded video segments that are associated with a video program and stored in a cache memory, a normalized cost measure relative to the sequence to which the encoded video segment belongs;
means for selecting one or more encoded video segments from among the encoded video segments in the plurality of sequences, based on the normalized cost measures; and
means for removing the selected encoded video segments from the cache memory.

27. The apparatus of claim 26, wherein each sequence in the plurality of sequences comprises an encoded version of the video program encoded at a respective encoding rate.

28. The apparatus of claim 27, wherein the means for determining the normalized cost measure of a respective encoded video segment within a respective sequence further comprises:
means for dividing a first encoding rate associated with the respective encoded video segment by a second encoding rate associated with the respective sequence to which the respective encoded video segment belongs.

29. The apparatus of claim 28, wherein the means for selecting one or more encoded video segments from among the encoded video segments in the plurality of sequences, based on the normalized cost measures, further comprises:
means for selecting an encoded video segments having a lowest normalized cost measure among the encoded video segments in the plurality of sequences.

30. The apparatus of claim 26, wherein the cache memory comprises a random access memory in a cache device.

31. An apparatus for managing data, the apparatus comprising:
means for determining, for each encoded video segment within each of a plurality of sequences of encoded video segments that are associated with a video program, a normalized cost measure relative to the sequence to which the encoded video segment belongs;
means for selecting one or more encoded video segments from among the encoded video segments in the plurality of sequences, based on the normalized cost measures; and
means for transmitting the selected encoded video segments to a cache memory.

32. The apparatus of claim 31, wherein each sequence in the plurality of sequences comprises an encoded version of the video program encoded at a respective encoding rate.

33. The apparatus of claim 32, wherein the means for determining the normalized cost measure of a respective encoded video segment within a respective sequence further comprises:
means for dividing a first encoding rate associated with the respective encoded video segment by a second encoding rate associated with the respective sequence to which the respective encoded video segment belongs.

34. The apparatus of claim 33, wherein the means for selecting one or more encoded video segments from among the encoded video segments in the plurality of sequences, based on the normalized cost measures, further comprises:
means for selecting an encoded video segments having a highest normalized cost measure among the encoded video segments in the plurality of sequences.
